(19) United States
(12) Patent Application Publication
(10) Pub. No.: US 2009/0147407 A1
(43) Pub. Date: Jun. 11, 2009

(54) Integrated flexure tongue micro-actuator

(76) Inventors: Fu-Ying Huang, San Jose, CA (US); Jifang Tian, Fremont, CA (US)

Correspondence Address: HITACHI C/O WAGNER BLECHER LLP, 123 WESTRIDGE DRIVE, WATSONVILLE, CA, 95076, US

(21) Appl. No.: 12/001,249

(22) Filed: Dec. 10, 2007

(51) Int. Cl. G11B 5/56

(52) U.S. Cl. 360/294.4

(57) ABSTRACT

An integrated flexure tongue micro-actuator is disclosed. One embodiment provides a first arm on a first side of the flexure tongue, the first arm approximately perpendicular with the flexure tongue. In addition, a second arm is provided on a second side of the flexure tongue, the second arm approximately parallel with the first arm. At least one piezoelectric device is coupled with either the first arm or the second arm and a slider is disposed between and coupled with the first am and the second arm.

### TECHNICAL FIELD

The present invention relates to the field of hard disk drive development, and more particularly to an integrated flexure tongue micro-actuator.

### BACKGROUND ART

A Hard disk drive (HDD) is used in almost all computer system operations. In fact, most computing systems are not operational without some type of HDD to store the most basic computing information such as the boot operation, the operating system, the applications, and the like. In general, the HDD is a device which may or may not be removable, but without which the computing system will generally not operate.

In operation, the hard disk is rotated at a set speed via a spindle motor assembly having a central drive hub. There are tracks at known intervals across the disk. When a request for a read of a specific portion or track is received, the HDD aligns a read/write head, via an arm, over the specific track location and the head reads the information from the disk. In the same manner, when a request for a write of a specific portion or track is received, the HDD aligns the head, via the arm, over the specific track location and the head writes the information to the disk.

However, the ability of a HDD to quickly read and write data to and from the magnetic storage media is highly dependent on the performance of the electromechanical components of the HDD. Modern HDDs, such as HDDs implementing magnetic storage media, are plagued by imperfections in their design which serve to degrade the efficiency with which such HDDs can operate. Thus, there exists a need for a more efficient paradigm for maximizing the operating efficiency of a HDD.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An integrated flexure tongue micro-actuator is disclosed. One embodiment provides a first arm on a first side of the flexure tongue, the first arm approximately perpendicular with the flexure tongue. In addition, a second arm is provided on a second side of the flexure tongue, the second arm approximately parallel with the first arm. At least one piezoelectric device is coupled with either the first arm or the second arm and a slider is disposed between and coupled with the first am and the second arm.

### BRIEF DESCRIPTION OF THE DRAWINGS

FIG. 1 is a plan view of an HDD with cover and top magnet removed in accordance with one embodiment of the present invention.

FIG. 2 is an isometric view of an actuator arm and a magnified, cross-sectional view of a head gimbal assembly (HGA), in accordance with an embodiment of the present invention.

FIG. 3A is a top view of a flexure tongue in accordance with one embodiment of the present invention.

FIG. 3B is a top view of a flexure tongue in accordance with one embodiment of the present invention.

FIG. 4 is a side view of an integrated flexure tongue micro actuator with slider in accordance with one embodiment of the present invention.

FIG. 5 is a flowchart of a method for forming an integrated flexure tongue micro-actuator in accordance with one embodiment of the present invention.

### BEST MODES FOR CARRYING OUT THE INVENTION

Reference will now be made in detail to the alternative embodiment(s) of the present invention. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

The discussion will begin with an overview of a HDD and components connected therewith. The discussion will then focus on embodiments of a method and system for utilizing a card-through-connector fastener to reduce connector distortion in particular.

### Overview

In general, the present technology provides an integrated flexure tongue micro-actuator. Further, the present technology is performed without requiring an addition of a micro-actuating section between the slider and the flexure. Moreover, the described benefits are realized with minimal modification to the overall HDD manufacturing process in general and to the flexure tongue structure in particular.

### Operation

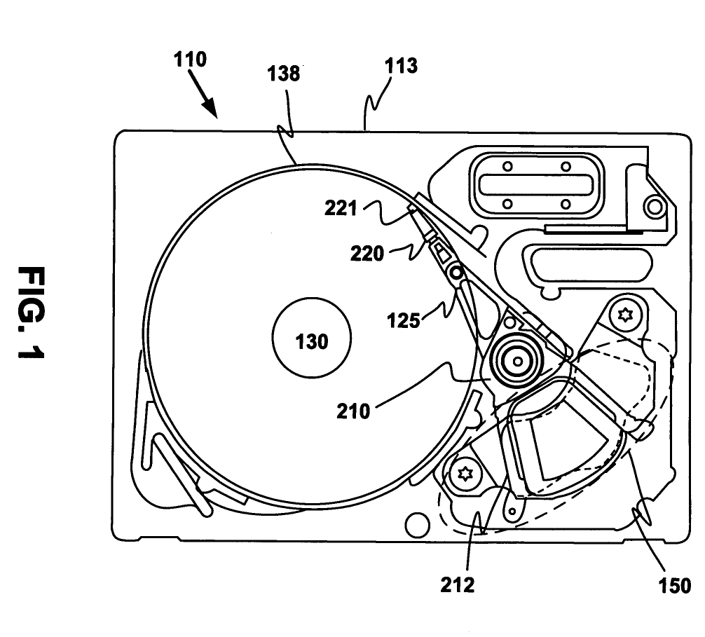

With reference now to FIG. 1, a schematic drawing of one embodiment of an information storage system including a magnetic hard disk file or HDD 110 for a computer system is shown. Although, only one head and one disk surface combination are shown. What is described herein for one head-disk combination is also applicable to multiple head-disk combinations. In other words, the present technology is independent of the number of head-disk combinations.

In general, HDD 110 has an outer housing 113 usually including a base portion (shown) and a top or cover (not shown). In one embodiment, housing 113 contains a disk pack having at least one media or magnetic disk 138. The disk pack (as represented by disk 138) defines an axis of rotation and a radial direction relative to the axis in which the disk pack is rotatable.

A spindle motor assembly having a central drive hub 130 operates as the axis and rotates the disk 138 or disks of the disk pack in the radial direction relative to housing 113. An actuator assembly 140 includes one or more actuator arms 210. When a number of actuator arms 210 are present, they are usually represented in the form of a comb that is movably or pivotally mounted to base/housing 113. A controller 150 is also mounted to base 113 for selectively moving the actuator arms 210 relative to the disk 138. Actuator assembly 140 may be coupled with a connector assembly to convey data between arm electronics and a host system, such as a computer, wherein HDD 110 resides.

In one embodiment, each actuator arm 210 has extending from it at least one cantilevered integrated lead suspension (ILS) 224. The ILS 224 may be any form of lead suspension that can be used in a data access storage device. The level of integration containing the slider 221, ILS 224, and read/write head is called the Head Gimbal Assembly (HGA).

The ILS 224 has a spring-like quality, which biases or presses the air-bearing surface of slider 221 against disk 138 to cause slider 221 to fly at a precise distance from disk 138. ILS 224 has a hinge area that provides for the spring-like quality, and a flexing interconnect that supports read and write traces and electrical connections through the hinge area. A voice coil 212, free to move within a conventional voice coil motor magnet assembly is also mounted to actuator arms 210 opposite the head gimbal assemblies. Movement of the actuator assembly 210 by controller 150 causes the head gimbal assembly to move along radial arcs across tracks on the surface of disk 138.

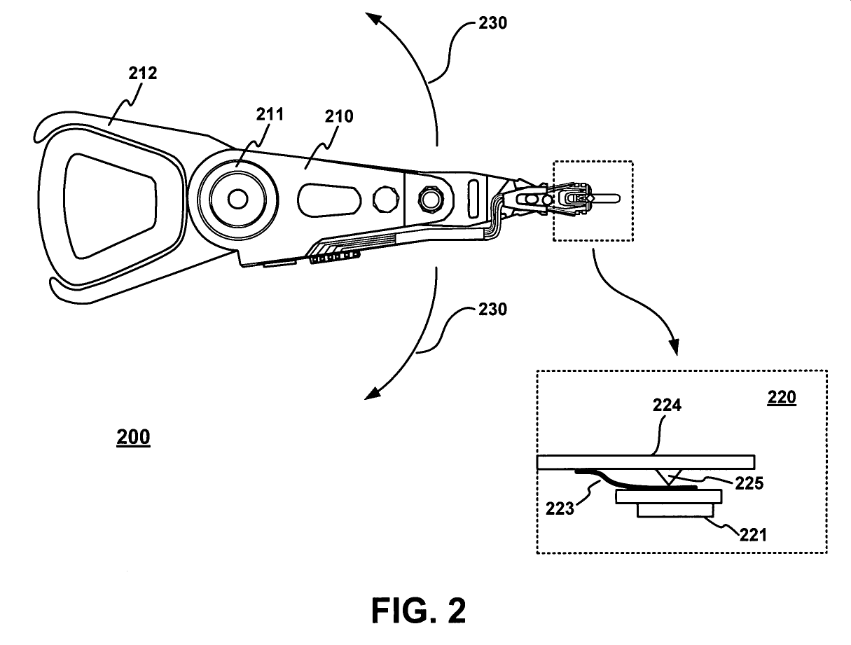

With reference now to FIG. 2, an actuator arm configuration 200 in accordance with an embodiment of the present invention is shown. An actuator arm 210 is coupled with a head gimbal assembly 220 that comprises a magnetic read/write head (not shown). The magnetic read/write transducer or head is coupled with a slider 221. The head gimbal assembly 220 further comprises a flexure 223 coupled with a lead suspension 224. In one embodiment, the flexure 223 supports the slider 221 relative to the lead suspension 224, while a dimple 225 separates the flexure 223 from the lead suspension 224. Movement (illustrated by arrows 230) of the actuator arm 210 moves the head gimbal assembly 220 relative to the magnetic storage medium 138 such that the read/write head can magnetically read data from and/or magnetically write data to different points along the surface of the magnetic storage medium 138.

In one embodiment, each actuator arms 210 in HDD 110 has its own head gimbal assembly and the head gimbal assemblies of the plurality of parallel actuator arms 210 operate in unison with one another. However, in another embodiment HDD 110 may use multiple actuator arms 210 configured to move independently of one another.

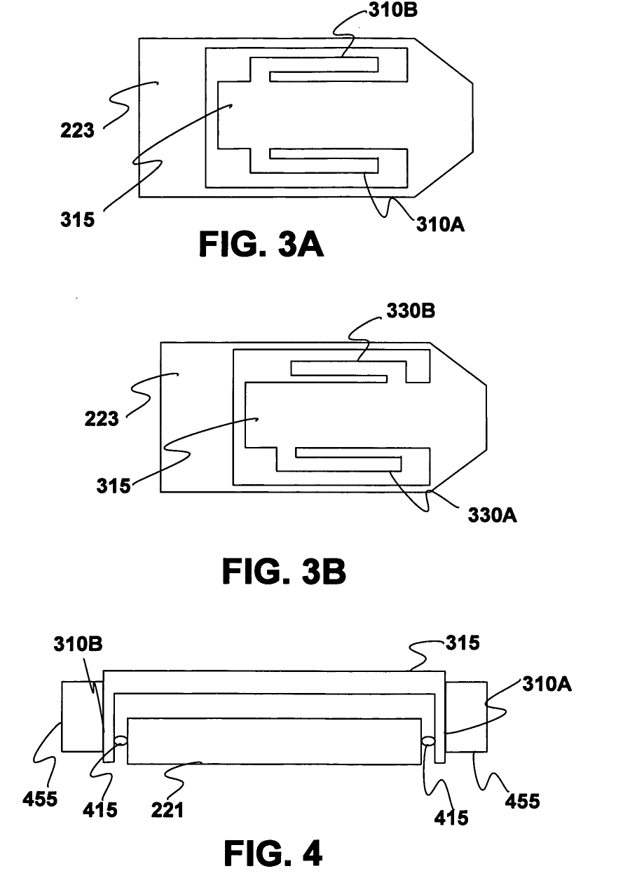

With reference now to FIG. 3A, a flexure 223 having a flexure tongue 315 (or flexure body) and a first arm 310A and a second arm 310B is shown in accordance with one embodiment of the present technology. In general, the flexure 223 and the components associated therewith are formed during the manufacturing process of the flexure. For example, the flexure tongue 315 and arms 310A and 310B may be formed at the same time. In other words, the flexure 223 may be formed via etching, milling, stamping, pressing, cutting, or the like. In another embodiment, the arms 310A and 310B may be added after the manufacture of the flexure 223.

As shown in FIG. 3A, the arms 310A and 310B are formed parallel to each other. That is, the shoulder of the arms 310A and 310B are directly across from one another with respect to the flexure tongue 315. In another embodiment, as shown in FIG. 3B, arms 330A and 330B may be formed offset from one another. That is, the shoulder of the arms 330A and 330B are offset from one another with respect to the flexure tongue 315. Although there are two versions of arms shown in FIGS. 3A and 3B, the present technology is not limited to the two different illustrations provided. The present technology is well suited to the arms being offset at any range.

With reference now to FIG. 4, a side view of an integrated flexure tongue micro-actuator is shown in accordance with one embodiment of the present technology. In general, FIG. 4 illustrates the manipulation of flexure tongue 315 and flexure arms 310A and 310B to form a framework for the integrated flexure tongue micro-actuator 400. As shown in FIG. 4, the arms 310A and 310B are bent at an angle of approximately 90 degrees with respect to the flexure tongue 315. At least one Piezoelectric (PZT) device 455 (although two are shown for purposes of clarity) is then provided on the outside portion of the arms 310A and/or 310B.

The slider 221 is also coupled with the inside of arms 310A and 310B without making contact with the flexure tongue 315. In one embodiment, the slider is bonded to the arms 310A and 310B using a bonding material 415 provided in only a single spot location, or a number of spot locations. In one embodiment, the bonding material used to bond the slider 221 to the flexure arms 310A and 310B may be rugged enough to withstand vibrations occurring during HDD 110 operation so that the components remain bonded together.

With reference again to FIG. 2, the movement of the actuator arm 210 (indicated by arrows 230) causes the head gimbal assembly 220 to move along radial arcs across tracks on the magnetic storage medium 138 until the magnetic read/write head settles on its set target track. The magnetic read/write transducer or head coupled with the slider 221 reads data from and magnetically writes data to data arrays comprising radially spaced data information tracks located on the surface of the magnetic storage medium 138. This type of movement of the actuator arm 210 is generally referred to as “single-stage actuation”, because the slider, which is coupled with the actuator arm 210 by means of the head gimbal assembly 220, is rotated relative to the pivot assembly 211.

One embodiment of the present technology implements a system of “double-stage actuation” wherein operation of both the voice coil 212 and the integrated flexure tongue micro-actuator 400 has a dynamic effect on the present location of the slider 221 relative to the magnetic storage medium 138. Specifically, the integrated flexure tongue micro-actuator 400 is configured to operate as a small motor that takes into account the sway and other vibrations experienced by the slider 221, wherein such vibrations are the result of, inter alia: (1) the inertia generated by the movement 230 of the actuator arm 210, and (2) the windage created by the high-speed rotation 131 of disk 138. The integrated flexure tongue micro-actuator 400 then adjusts for these factors by moving the slider 221 relative to disk 138 such that the magnetic read/write head is in a better position to magnetically read data from and magnetically write data to specific data arrays located on the surface of disk 138.

### Slider Rotation Sing a Pure Rotary Force

Generally, the operation of a hard disk drive (HDD) 110 may encounter high frequency vibrations which decrease overall drive performance. Such vibrations generally occur as the result of an inertial force generated by the actuator arm 210 rapidly rotating in order to seek data tracks on the surface of disk 138, or as the result of a windage force exerted to the slider 221 due to the high rate of speed with which the disk 138 rotates relative to the slider 221. Thus, during normal operation, both the actuator arm 210 and the suspension experience a large amount of mechanical excitation due to these vibrations, which serves to degrade the ability of the read/write heads in the head stack assembly (HSA) to read data from and write data to the data tracks on the disks' surfaces because the slider 221 is not able to place these heads in the ideal locations for data communication due to these vibrations.

One way to address the vibrations is to increase stroke and/or stiffness characteristics of a head gimbal assembly (HGA). In general, stroke refers to the range of motion with which the micro-actuator moves the slider 221 relative to a magnetic disk in the drive. In other words, stroke is the absolute correction range with which a micro-actuator can operate. It is beneficial for a head gimbal assembly (HGA) to have a relatively high degree of stroke so that the micro-actuator can better position the slider 221, and consequently the magnetic read/write head, over the data arrays on the surface of the magnetic disk. Thus, a higher degree of stroke translates into more efficient data transfer between the read/write head and the magnetic storage medium.

It is also beneficial for the components of the head gimbal assembly (HGA) to have a relatively high degree of stiffness, which refers to the degree of flexibility associated with the components of the head gimbal assembly (HGA). For instance, if the micro-actuator device is highly flexible, then it will be more sensitive to a windage force generated during operation of the hard disk drive (HDD). Thus, it is highly beneficial to the operation of a head gimbal assembly (HGA) that the micro-actuator be as stiff as possible, while still being able to function for its intended purpose. In particular, the micro-actuator should be designed to be fairly rigid where the slider 221 is coupled. The reason for this design parameter is that when the slider 221 is experiencing a windage force, a vibration will occur which is directly correlated with the stiffness of the system.

Normally, stroke and stiffness adjustments constitute a tradeoff. For example, a design having a relatively high degree of stroke will probably have a relatively low degree of stiffness. This, in turn, would cause the head gimbal assembly to experience a larger degree of windage excitation in exchange for a broader absolute correction range. In contrast, past implementations that succeeded in realizing a higher degree of stiffness, and thus a lower windage excitation, also experienced a reduced stroke. Therefore, there currently exists a need in the field of hard disk drive (HDD) design in which the stroke and stiffness associated with the components of a head gimbal assembly (HGA) can be simultaneously increased.

The present technology solves this problem by providing an integrated flexure tongue micro-actuator 400 that creates a rotary force and applies this force to the slider 221 via the PZT device(s) 455 coupled with the arms 310A and 310B of the flexure 315. For example, the slider 221 flies above the magnetic storage medium 138, when an electrical input signal is received at PZT device(s) 455, the PZT device(s) 455 elongate thereby applying a force to the arms 310A and 310B translating into a rotary force. The rotary force is translated to slider 221 such that slider 221 is rotated in a direction corresponding to the applied rotary force. The inherent stiffness of the integrated flexure tongue micro-actuator 400 translates into a larger rotary force being applied to the slider 221, which in turn creates a larger degree of stroke, or range of motion to correct defects in the positioning of the slider 221 relative to the data tracks located on the surface of disk 138.

In one embodiment, integrated flexure tongue micro-actuator 400 is configured to be as stiff as possible while still being able to couple with the lead suspension 224. As stated above, such component stiffness decreases the level of windage excitation and leads to smaller vibrations being generated in response to inertia forces created during dynamic actuation.

Further, because the micro-actuator is built directly into the flexure design, there is no significant mass change to generate an inertia that can amplify vibrations delivered to the slider 221. In addition, the force created by integrated flexure tongue micro-actuator 400 is applied to the slider 221 such that the slider 221 rotates relative to disk 138. In one embodiment, the slider 221 is rotated relative to the magnetic storage medium 138 such that the transmission fly-height 318 of the magnetic read/write head is kept constant. In this manner, the system 400 could be configured to provide a certain level of predictability regarding the efficiency with which the magnetic read/write head 310 is able to magnetically read data from and magnetically write data to the magnetic storage medium.

### Piezoelectric Devices

In general, piezoelectric devices that change shape in response to an applied voltage are implemented such that a change in applied voltage changes the shape of the piezoelectric devices thereby providing a force to one or more of the arms 310A and/or 310B translating into a rotary force being applied to the slider 221. For example, multiple piezoelectric devices are positioned in close proximity such that a change in shape of these devices creates push forces that are applied to specific locations on the arms 310A and/or 310B. The combination of these push forces being simultaneously applied at such specific locations creates a rotary force that is ultimately applied to slider 221 such that the magnetic read/write head attached to the slider are rotated relative to disk 138.

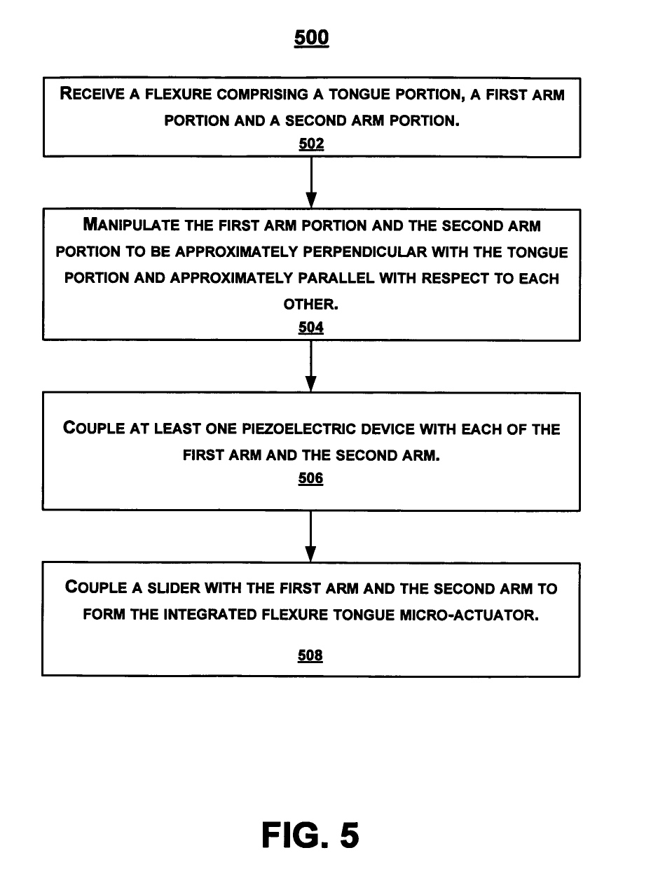

With reference now to 502 of FIG. 5 and also to FIG. 3, one embodiment receives a flexure 223 having a tongue portion 315, a first arm 310A and a second arm 310B. As described herein, in one embodiment, the flexure 223 may be formed from a single piece. However, in another embodiment, the flexure 223 may be a collaboration of distinct pieces.

Referring now to 504 of FIG. 5 and also to FIG. 4, one embodiment manipulates the first arm portion 310A and the second arm portion 310B to be approximately perpendicular with the tongue portion 315 and approximately parallel with respect to each other. Although the arms are described in one embodiment as being approximately perpendicular and approximately parallel, there is an amount of angular distances or ranges which may be used. For example, instead of perpendicular, the arms 310A and 310B may be at or less than a 45 degree angle with respect to the tongue portion 315. In other words, the angle of the arms may have great latitude.

With reference now to 506 of FIG. 5 and also to FIG. 4, one embodiment couples at least one piezoelectric device 455 with each of the first arm 310A and the second arm 310B. In one embodiment, the piezoelectric devices 455 may be coupled with arms 310A and 310B by means of adhesive capillary intakes. In another embodiment, other methods of adhesion may also be implemented so long as the piezoelectric devices 455 remain coupled with the silicon substrate 502 during operation of the HDD 110.

With reference now to 508 of FIG. 5 and also to FIG. 4, one embodiment couples a slider 221 with first arm 310A and second arm 310B to form the integrated flexure tongue micro-actuator 400. In operation, as stated herein, piezoelectric devices 455 are configured to change shape when an electronic input signal is provided. For instance, in one embodiment, the piezoelectric devices 455 are configured to expand in response to an electronic input signal. This expansion causes the piezoelectric devices 455 to generate push forces which are applied to the arms 310A and 310B. In one embodiment, the application of these push forces causes the slider 221 to rotate in a pure rotary motion relative to the flexure tongue 315. However, in another embodiment, the application of these push forces causes the slider 221 to rotate in a less than pure rotary motion relative to the flexure tongue 315.

In another embodiment, the piezoelectric devices 455 are configured to constrict in response to an electronic input signal. For example, the piezoelectric devices 455 may be coupled with the precise locations on the arms 310A and 310B such that the constriction of the piezoelectric devices 455 generates pull forces that are applied to the arms 310A and 310B. In one embodiment, the application of these pull forces would cause slider 221 to rotate in a pure rotary motion relative to the flexure tongue 315. However, in another embodiment, the application of these push forces causes the slider 221 to rotate in a less than pure rotary motion relative to the flexure tongue 315.

In general, piezoelectric devices 455 may be comprised of various materials that are capable of exhibiting piezoelectric effects. In one embodiment, the piezoelectric devices 455 are comprised of lead zirconate titanate (Pb(ZrTi)O₃), which is a ceramic material commonly known as “PZT”. In one embodiment, the PZT material in the piezoelectric devices 455 cause only small changes in shape in response to a change in voltage applied to these substrates 455. Such small changes in the shapes of the piezoelectric substrates 455 cause the push forces to be relatively weak. This enables integrated flexure tongue micro-actuator 400 to make miniscule, high-precision changes to the position of the magnetic read/write head relative to disk 138 because the application of smaller push forces causes slider 221 to rotate a shorter distance.

In another embodiment, the piezoelectric devices 455 are comprised of multiple layers of piezoelectric material. For instance, the piezoelectric devices 455 could comprise a plurality of layers (e.g., 2-7 layers each) of PZT. In general, the application of multilayered piezoelectric substrates would alter the manner in which the piezoelectric devices 455 move in response to an applied voltage. Thus, a multilayered piezoelectric configuration could be implemented in order to further increase the stroke that can be achieved by integrated flexure tongue micro-actuator 400, or to vary the timing according to specific design specifications by taking advantage of the converse piezoelectric effect realized by the combination of the multilayered substrates.

Further, by increasing the girth of the piezoelectric devices 455, the stiffness of the head gimbal assembly 220 will necessarily be increased. For instance, although ceramic PZT may be bent in response to an applied voltage, PZT is nevertheless a solid material exhibiting a certain degree of inherent resistance to vibrational forces. Thus, by increasing the amount of material that comprises the piezoelectric devices 455, these devices will become increasingly resistant to vibrational forces, while still exhibiting a converse piezoelectric effect in response to an applied voltage.

In an alternative embodiment, both the stroke and stiffness of the head gimbal assembly 220 are increased by increasing the length of the piezoelectric devices 455. Mechanically speaking, when longer piezoelectric materials are implemented, the piezoelectric devices 455 will experience a more significant change in shape, which in turn will create stronger push forces. The application of stronger push forces to the arms 310A and 310B causes slider 221 to rotate a greater distance which increases the stroke of the head gimbal assembly 220. In addition, since an increase in the length of the piezoelectric devices 455 will require a greater amount of piezoelectric material, increasing the length of the piezoelectric devices also increases the stiffness of integrated flexure tongue micro-actuator 400.

In one embodiment, the strength of the electronic input signal that is applied to the piezoelectric devices is varied in order to alter the pure rotary motion that is applied to the slider 221. For instance, the piezoelectric devices 455 could be configured such that a stronger electronic input signal causes a more significant change in shape. Further, the arms 310A and 310B could be configured such that a more significant change in shape of the piezoelectric devices 455 causes slider 221 to be rotated a greater distance. This serves to increase the overall stroke of the head gimbal assembly 220.

In another embodiment, the piezoelectric devices 455 are configured such that a stronger electronic input signal increases the speed with which the devices 455 change shape. Further, the arms 310A and 310B are configured such that a quicker change in shape of the piezoelectric devices 455 increases the speed with which slider 221 rotates. This serves to increase the overall speed with which the integrated flexure tongue micro-actuator 400 can adjust the location of slider 221 relative to disk 138.

In another embodiment, the pure rotary micro-actuator 410 is further configured to recognize and correct for vibrations present in the head gimbal assembly 220 during operation of the HDD 110. For instance, the piezoelectric devices 455 could comprise a first piezoelectric material exhibiting a direct piezoelectric effect, wherein the material generates an electrical current in response to applied physical stress, as well as a second piezoelectric material exhibiting a converse piezoelectric effect, as previously discussed. In this manner, the piezoelectric devices 455 could be configured to bend in response to a sensed vibrational force, and send an electronic signal to the integrated flexure tongue micro-actuator 400. Upon receiving this electronic signal, the integrated flexure tongue micro-actuator 400 would recognize that the piezoelectric devices 455 have been bent, and then send an electronic signal to the devices 455 that causes them to bend in the opposite direction. This type of controlled countermeasure would help to alleviate or reduce vibrations.

The aforementioned embodiment is useful because it increases the precision with which the integrated flexure tongue micro-actuator 400 is able to displace slider 221 to a specific location because vibrations that effect the positioning of slider 221 relative to the disk 138 are attenuated. In addition, there is a smaller chance of drive failure because the probability of the slider 221 contacting disk 138 due to a vibration in the head gimbal assembly 220 will be decreased. In other words, it is less likely that the slider 221 and disk 138 would collide.

Thus, embodiments of the present invention provide a method and apparatus for forming and utilizing an integrated flexure tongue micro-actuator. Furthermore, embodiments described herein provide an integrated flexure tongue micro-actuator that weighs significantly less than silicon substrate micro-actuators. In addition, the benefits described herein are realized with minimal modification to the overall HDD manufacturing process in general and to the HGA and flexure in particular.

Example embodiments of the present technology are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An integrated flexure tongue micro-actuator comprising:
a first arm on a first side of said flexure tongue, said first arm approximately perpendicular with said flexure tongue;
a second arm on a second side of said flexure tongue, said second arm approximately parallel with said first arm;
at least one piezoelectric device coupled with either said first arm or said second arm; and
a slider disposed between and coupled with said first am and said second arm.

2. The integrated flexure tongue micro-actuator of claim 1 wherein said at least one piezoelectric device provides a force to either said first arm or said second arm in response to an electrical input signal, said force resulting in a rotating moment for said slider disposed between and coupled with said first am and said second arm.

3. The integrated flexure tongue micro-actuator of claim 1 further comprising:
at least a second piezoelectric device coupled with the other of said first arm or said second arm with which said at least one piezoelectric device is coupled.

4. The integrated flexure tongue micro-actuator of claim 3 wherein said at least a second piezoelectric device provides a force to the other of said first arm or said second arm in response to an electrical input signal, said force resulting in a rotating moment for said slider disposed between and coupled with said first am and said second arm.

5. The integrated flexure tongue micro-actuator of claim 1 wherein a coupling point between said first arm on said first side of said flexure tongue and a coupling point between said second arm on said second side of said flexure tongue are approximately aligned.

6. The integrated flexure tongue micro-actuator of claim 1 wherein a coupling point between said first arm on said first side of said flexure tongue and a coupling point between said second arm on said second side of said flexure tongue are offset.

7. The integrated flexure tongue micro-actuator of claim 1 wherein said first arm and said second arm are formed as a portion of said flexure tongue during manufacture of said flexure tongue.

8. The integrated flexure tongue micro-actuator of claim 1 wherein glue is utilized to couple said slider with said first am and said second arm.

9. A hard disk drive comprising:
a housing;
a magnetic storage medium coupled with said housing, said magnetic storage medium rotatable relative to said housing;
an actuator arm coupled with said housing, said actuator arm having a flexure coupled therewith said flexure comprising:
a flexure tongue formed in conjunction with said flexure;
a first arm on a first side of said flexure tongue, said first arm approximately perpendicular with said HA flexure tongue;
a second arm on a second side of said flexure tongue, said second arm approximately parallel with said first arm;
at least one piezoelectric device coupled with either said first arm or said second arm; and
a slider disposed between and coupled with said first am and said second arm.

10. The hard disk drive of claim 9, wherein said at least one piezoelectric device provides a force to either said first arm or said second arm in response to an electrical input signal, said force resulting in a rotating moment for said slider disposed between and coupled with said first am and said second arm.

11. The hard disk drive of claim 9 further comprising:
at least a second piezoelectric device coupled with the other of said first arm or said second arm with which said at least one piezoelectric device is coupled.

12. The hard disk drive of claim 11 wherein said at least a second piezoelectric device provides a force to the other of said first arm or said second arm in response to an electrical input signal, said force resulting in a rotating moment for said slider disposed between and coupled with said first am and said second arm.

13. The hard disk drive of claim 9 wherein a coupling point between said first arm on said first side of said HGA flexure tongue and a coupling point between said second arm on said second side of said HGA flexure tongue are approximately aligned.

14. The hard disk drive of claim 9 wherein a coupling point between said first arm on said first side of said flexure tongue and a coupling point between said second arm on said second side of said flexure tongue are offset.

15. The hard disk drive of claim 9 wherein said first arm and said second arm are formed as a portion of said flexure tongue during manufacture of said flexure tongue.

16. The hard disk drive of claim 9 wherein glue is utilized to couple said slider with said first am and said second arm.

17. A method of forming an integrated flexure tongue micro-actuator comprising:
receiving a flexure comprising a tongue portion, a first arm portion and a second arm portion;
manipulating said first arm portion and said second arm portion to be approximately perpendicular with said tongue portion and approximately parallel with respect to each other;
coupling at least one piezoelectric device with each of said first arm and said second arm; and
coupling a slider with said first arm and said second arm to form said integrated flexure tongue micro-actuator.

18. The method of claim 17 further comprising:
an electrical input provider electrically coupled with said piezoelectric device of said first arm and said second arm, such that in response to an electrical input with either or both of said piezoelectric device of said first arm and said second arm a force to either said first arm or said second arm is generated, said force resulting in a rotating moment for said slider coupled with said first am and said second arm.

19. The method of claim 17 further comprising:
forming said tongue portion, said first arm portion and said second arm portion such that a coupling point between said first arm on said first side of said tongue portion and a coupling point between said second arm on said second side of said tongue portion are approximately aligned.

20. The method of claim 17 further comprising:
forming said tongue portion, said first arm portion and said second arm portion such that a coupling point between said first arm on said first side of said tongue portion and a coupling point between said second arm on said second side of said tongue portion are offset.

21. The method of claim 17 further comprising:
utilizing glue to couple said slider with said first arm portion and said second arm portion; and
ensuring said slider is not in contact with said tongue portion.
